(19) United States
(12) Patent Application Publication
(10) Pub. No.: US 2005/0028649 A1
(43) Pub. Date: Feb. 10, 2005

(54) Box wrench with hinged socket

(76) Inventor: Dan Settanni, Bethel, CT (US)

Correspondence Address: MARK LEVY & ASSOCIATES, PLLC, PRESS BUILDING, SUITE 902, 19 CHENANGO STREET, BINGHAMTON, NY, 13901, US

(21) Appl. No.: 10/634,492

(22) Filed: Aug. 6, 2003

(51) Int. Cl. B25B 13/28

(52) U.S. Cl. 81/111

(57) ABSTRACT

An apparatus featuring a unique box wrench having a dual hinged socket is shown. A first element of the socket forms the distal end of a handle or lug. A second element engages the first element to form a socket cavity. The two elements are hinged to each other approximately halfway around the socket cavity. A pin can be inserted through a hole in the hinge teeth at both hinges in order to form the socket. Conversely, either pin can be removed from the hinge teeth to open the socket. Each hinge of the socket comprises an interlocking tooth profile in sectional view.

### FIELD OF THE INVENTION

This invention pertains to wrench-type tools and, more particularly, to a box wrench comprising a dual hinged socket that can encircle tubes, hoses, and bar stock in order to loosen and remove locking nuts that attach the tubing, hose, or bar stock to manifolds, engines, and machinery.

### BACKGROUND OF THE INVENTION

In the field of box wrenches, it is known to provide box wrenches having hinged jaw sockets that open and close about obstructed bolts, nuts, ferrules, and threaded connectors. Such a box wrench is illustrated in U.S. Pat. No. 5,131,300, issued on Jul. 21, 1992 to Gordon S. Daniel for OPENABLE AND CLOSABLE BOX WRENCH.

The purpose of fabricating hinged sockets for box wrenches lies in their ability to easily encircle obstructed nuts and bolts. Bolt or nut obstructions often occur when tubing and shafts are attached in confined spaces to engines or other machinery. In these situations, it is often found that open-ended wrenches cannot reach the nuts or bolts. Where such wrenches have access, they are usually forced into awkward angles with respect to the threaded connections or they have a small swing space and/or mechanical leverage.

It is also observed that working in tight spaces with open-ended tools is inconvenient because open-ended wrenches often fall off their nuts and bolts.

The box wrench shown in the aforementioned patent is a stand-alone tool, which is attachable to a ratchet or other handle that acts as the locking mechanism between the hinged sections of the socket. Each wrench is a given size and fits only one size bolt or nut. In addition, the box wrench profile is higher as a result of being attachable to a handle.

The box wrench of the present invention can be fabricated as part of the handle, thus providing a low profile.

The inventive wrench may be provided as a set of individual wrenches, each optimized to fit a particular size nut. In alternate embodiments, the box wrench of this invention can be fabricated with one of its jaws fixed in the handle and the other juxtaposed to its mating jaw. This allows the socket to expand or shrink in size. This provides a single tool that fits a range of nut and bolt sizes.

The box wrench of the current invention is hinged on either one or both sides, thus allowing the user, in the latter case, to dismantle the wrench from either end.

### SUMMARY OF THE INVENTION

In accordance with the present invention, there is featured a box wrench that has a dual hinged socket. A first part of the socket forms part of a handle or lug, with two distal ends. The second part of the box wrench is hinged to the respective distal ends of the first part of the box wrench, thus forming two hinged distal ends. In a first embodiment of the inventive wrench, a permanent hinge pin is provided at one of the hinged distal ends. This arrangement holds the handle and the second part of the wrench together and prevents dissassembly and possible loss of one of the two parts of the wrench. In alternate embodiments of the inventive wrench, a pin can be inserted through a hole in the hinge teeth at either hinged, distal end in order to form the socket. Conversely, either pin can be removed from the hinge teeth at either distal end in order to open the socket. Each distal end in sectional view comprises an interlocking tooth profile. The tooth on each end of the first part interlocks with the teeth of the second part.

In another alternate embodiment, one of the distal ends of the first part can be formed with an elongated tooth, which contains a plurality of spaced-apart pinholes. Sliding the elongated distal end of the first part past the distal end of the second part allows the socket to expand or contract in size. Thus, the box wrench of the invention can be assembled to fit a wide range of nut and bolt sizes.

It is an object of the invention to provide an improved box wrench.

It is another object of the present invention to provide a box wrench having greater versatility over its counterparts.

It is yet another object of the current invention to provide a single box wrench unit that can fit a range of nuts and bolts.

### BRIEF DESCRIPTION OF THE DRAWINGS

A complete understanding of the present invention may be obtained by reference to the accompanying drawings, when considered in conjunction with the subsequent detailed description, in which:

FIG. 1 illustrates a plan view of a first embodiment of the box wrench of this invention;

FIGS. 2a and 2b depict respective sectional views of the hinge of the box wrench shown in FIG. 1, as taken along lines A-A;

FIG. 3 shows a plan view of an alternate embodiment of the box wrench depicted in FIG. 1; and

FIG. 4 illustrates a front, in situ view of the box wrench of FIG. 1 being wrapped about a connecting hose.

For purposes of brevity and clarity, like components and elements of the apparatus of this invention will bear the same designations or numbering throughout the figures.

### DESCRIPTION OF THE PREFERRED EMBODIMENT

Generally speaking, an apparatus features a unique box wrench having a dual hinged socket. A first element of the socket forms the distal end of a handle or lug. A second element engages the first element to form a socket cavity. The two elements are hinged to each other approximately halfway around the socket cavity. In a first embodiment, a permanent hinge pin secures the two elements to one another. In alternate embodiments, a pin can be inserted through a hole in the hinge teeth at both hinges in order to form the socket. Conversely, either pin can be removed from the hinge teeth to open the socket. Each hinge of the socket comprises an interlocking tooth profile in sectional view.

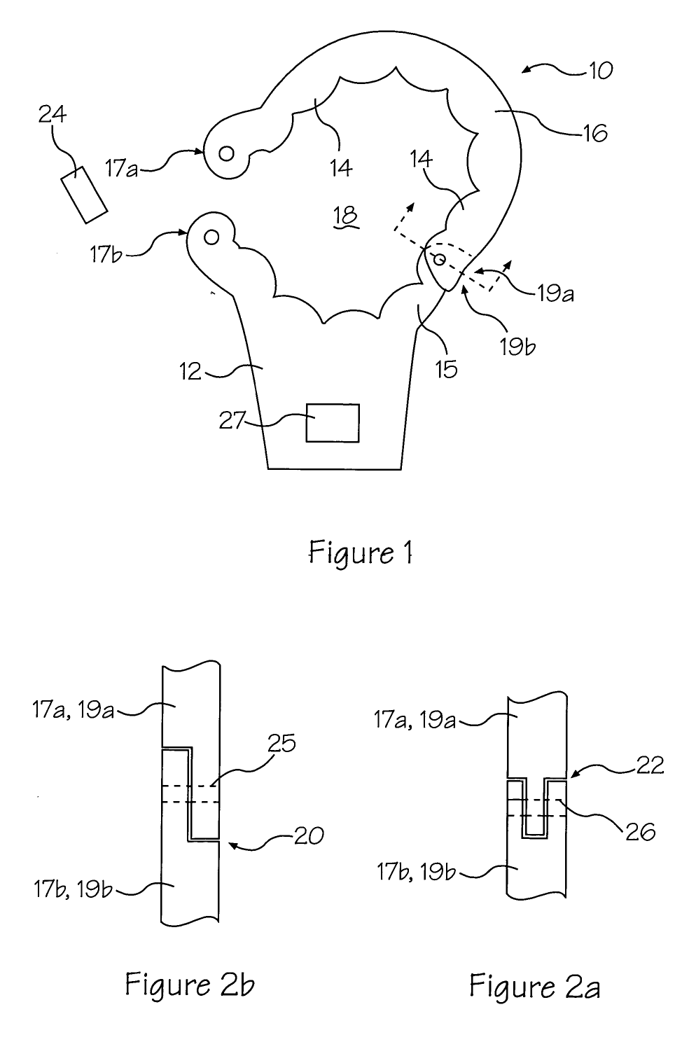

Now referring to FIG. 1, a first embodiment of the box wrench 10 of this invention is illustrated in plan view. The box wrench 10 comprises a handle 12 having a first circular-shaped portion 15 comprising a number of socket teeth 14 formed thereupon. Mating with the first circular-shaped portion 15 is a second circular-shaped portion 16 and a plurality of teeth 14. The circular-shaped portions 15 and 16 respectively unite to form a socket cavity 18. Each portion 15 and 16 mate with each other about their respective distal ends 17a and 17b and 19a and 19b, as shown in the first sectional view represented in FIG. 2a.

The distal ends interlock with each other to form a hinge 20, shown in sectional view in FIG. 2a, and in an alternate embodiment, hinge 22 in FIG. 2b. A locking pin 24 secures the teeth of the hinge and is pushed through holes 25 and 26 in FIGS. 2a and 2b, respectively. It will be recognized that locking pin 24 may be in the form of a permanent hinge pin such as a rivet or other such structure, not shown, as is well known to those of skill in the art. The permanent hinge pin could be located on either side of the wrench joining regions 17a and 17b or, alternately, 19a and 19b. The handle 12 can comprise a square hole 27 that accepts the nub of a ratchet (not shown).

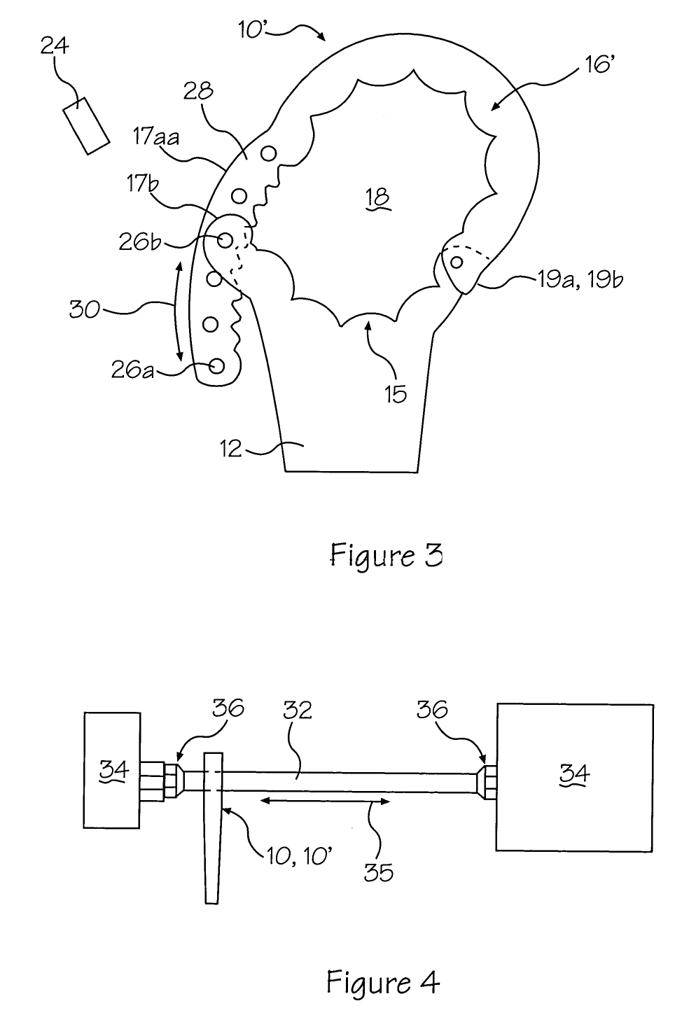

Referring to FIG. 3, a plan view of an alternate embodiment 10′ of the box wrench of FIG. 1, is shown. This embodiment features a socket cavity 18 that can shrink or expand to accommodate different nut and bolt sizes. The second circular shaped portion 16′ is adjustable with respect to the first portion 15 forming the socket cavity 18. Distal end 17aa comprises an elongated arm 28. The elongated arm 28 has a plurality of hinge holes 26a that slide past mating hinge hole 26b on distal end 17b when the elongated arm 28 is pushed past (arrow 30) the distal end 17b.

Referring to FIG. 4, the wrench 10 or 10′ is shown encircling a connecting hose 32 disposed between two oppositely disposed manifolds 34. The wrench 10 or 10′ is slid over the connecting hose 32 in order to engage the end nuts 36.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

1. A dual hinged box wrench, comprising:
a first socket element having a plurality of teeth disposed between a first distal end and a second distal end;
a second socket element having a plurality of teeth disposed between a third distal end and a fourth distal end, said first distal end of said first socket element engaging with said third distal end of said second socket element to form a first hinge, and said second distal end of said first socket element engaging with said fourth distal end of said second socket element to form a second hinge, whereby a socket cavity is formed thereby;
said first hinge and said second hinge comprising dual hinges; and
a locking hinge pin in each of said first and second hinges.

2. The dual hinged box wrench in accordance with claim 1, wherein said first socket element comprises a portion of a handle.

3. The dual hinged box wrench in accordance with claim 2, wherein said portion of a handle comprises a substantially square hole for receiving a ratchet, offset from the axis of said socket cavity, wherein said ratchet comprises one of the group: a handle and a lug attachment.

4. A dual hinged, expandable and contractable box wrench, comprising:
a first socket element having a plurality of teeth disposed between a first distal end and a second distal end;
a second socket element having a plurality of teeth disposed between a third distal end and a fourth distal end, said first distal end of said first socket element engaging with said third distal end of said second socket element to form a first hinge, and said second distal end of said first socket element engaging with said fourth distal end of said second socket element to form a second hinge, whereby a socket cavity is formed thereby, and further wherein said first distal end comprises an elongated arm that is slidably movable past said third distal end, whereby said socket cavity can be expanded and contracted to fit different nut and bolt sizes;
said first hinge and said second hinge comprising dual hinges; and
a locking hinge pin in each of said first and second hinges.

5. The dual hinged box wrench in accordance with claim 4, wherein said first socket element comprises a portion of a handle.

6. The dual hinged box wrench in accordance with claim 5, wherein said portion of a handle comprises a substantially square hole for receiving a ratchet offset from the axis of said socket cavity, wherein said ratchet comprises one of the group: a handle and a lug attachment.
